(19) United States
(12) Patent Application Publication
(10) Pub. No.: US 2002/0064677 A1
(43) Pub. Date: May 30, 2002

(54) Electric connector

(76) Inventors: Hiroyuki Moriuchi, Tokyo (JP); Yoshiichi Nakano, Tokyo (JP); Yoshihiro Tadokoro, Tokyo (JP)

Correspondence Address: BAKER & BOTTS, 30 ROCKEFELLER PLAZA, NEW YORK, NY, 10112

(21) Appl. No.: 09/953,649

(22) Filed: Sep. 17, 2001

(30) Foreign Application Priority Data
Sep. 18, 2000 (JP) 2000-281,195
Aug. 29, 2001 (JP) 2001-259,985

(51) Int. Cl. B32B 15/20

(52) U.S. Cl. 428/647; 428/648; 428/929

(57) ABSTRACT

An electric connector comprises a metal terminal or a metal shell joined to a core conductor or a metal layer portion of a substrate, wherein a Ni layer as an under layer is formed on at least a portion of the metal shell or the metal shell to be joined, and a Sn-Cu alloy layer having a copper content of 0.5-5.0 mass % is further formed on the Ni layer.

### BACKGROUND OF THE INVENTION

1. Field of the Invention

This invention relates to an electric connector comprising a metal terminal or a metal shell joined to a core conductor or a metal layer of a substrate, a joint portion of which being provided with a Ni layer as an under layer and a Pb-free surface-treated layer.

2. Description of Related Art

The electric connector is attached to a substrate of an electronic appliance, or connected to a core conductor of a cable. In the attachment to the substrate, it has widely been practiced to insert a metal terminal of the connector into a metal through-hole or the like located at the side of the substrate and then solder them, or to solder a metal shell itself as a housing of the connector or a portion thereof (a protruded leg portion) to a metal layer, the metal through-hole or the like located at the side of the substrate. On the other hand, in the connector for the cable, it has been practiced to solder the core conductor to a metal terminal (contact) built in the connector.

In order to improve the joining property of the metal terminal or the metal shell to the solder, a portion of the metal terminal or the metal shell to be soldered is frequently subjected to a solder plating as a pretreatment.

However, since the solder or the solder-plated portion frequently used contains lead (Pb) as a constituent thereof, when the electronic appliance or the electric connector is disposed, there is a problem that the environment is polluted by eluting out the Pb constituent from the electronic appliance or the electric connector.

To this end, it is recently attempted to develop Pb-free solders having an alloy composition such as Sn-3.5Ag-0.75Cu (in which a numeral value inscribed in front of each chemical symbol for an element means a mass percent, that is, “mass %”, and so forth), Sn-3.0Ag-0.5Cu, Sn-2.5Ag-1.0Bi-0.5Cu and the like as a solder for joining.

However, when the surface-treated layer is formed on the joint portion of the metal terminal of the metal shell of the electric connector, if the surface-treated layer is Pb-free, a sufficient wettability can not be obtained, so that the surface-treated layer still contains Pb in the present circumstances.

### SUMMARY OF THE INVENTION

Under the above circumstance, the invention is to provide an electrical connector fundamentally solving problems such as environment pollution and the like in which a Pb-free surface-treated layer is formed on the metal terminal or the metal shell.

According to a first aspect of the invention, there is the provision of in an electric connector comprising a metal terminal joined to a core conductor and/or a metal layer portion of a substrate, the improvement wherein a Ni layer as an under layer is formed on at least a portion of the metal terminal to be joined, and a Sn-Cu alloy layer having a copper content of 0.5-5.0 mass % is further formed on the Ni layer.

According to a second aspect of the invention, there is the provision of in an electric connector comprising a metal shell joined to a metal layer portion of a substrate, the improvement wherein a Ni layer as an under layer is formed on at least a portion of the metal shell to be joined, and a Sn-Cu alloy layer having a copper content of 0.5-5.0 mass % is further formed on the Ni layer.

In a preferable embodiment of the invention, both the Ni layer and the Sn-Cu alloy layer are formed by a wet plating method.

As seen from the above, in the electrical connector according to the invention, the surface-treated layer formed on the portion of the metal terminal or the metal shell to be joined to the core conductor or the metal layer of the substrate is a Pb-free surface-treated layer comprised of the Ni layer and the Sn-Cu alloy layer having a copper content of 0.5-5.0 mass %, whereby the joint portion of the metal terminal or the metal shell can be formed at a lead-free state.

Therefore, if the Pb-free solder is used in the joining to the Sn-Cu alloy layer, the perfectly Pb-free junction is obtained, whereby the problems that the environment is polluted by disposing the connector later are fundamentally solved.

And also, the properties of the surface-treated layer comprised of the Ni layer and the Sn-Cu alloy layer are equal to those of the conventional lead-containing solder plated layer forming no whisker.

Furthermore, it is possible to form the Sn-Cu alloy plated layer at a low cost as compared with the other Ag-containing plated layer and the like. And also, the plating solution for the formation of the Sn-Cu alloy plated layer is good in the stability and the amount of additives such as gloss agent and the like may be only small, so that the maintenance of the plating solution is performed easily.

### BRIEF DESCRIPTION OF THE DRAWINGS

The invention will be described with reference to the accompanying drawings, wherein:

FIG. 1 is a diagrammatically side view, partly shown in cross section, of an embodiment of an electric connector according to the invention;

FIG. 2 is an partly enlarged view of a metal terminal (contact) of the electric connector shown in FIG. 1;

FIG. 3 is a partial perspective view of another embodiment of the electric connector according to the invention;

FIG. 4 is a bottom view of a part of the electric connector shown in FIG. 3; and

FIG. 5 is a diagrammatically partial perspective view of the other embodiment of the electric connector according to the invention.

### DETAILED DESCRIPTION OF THE INVENTION

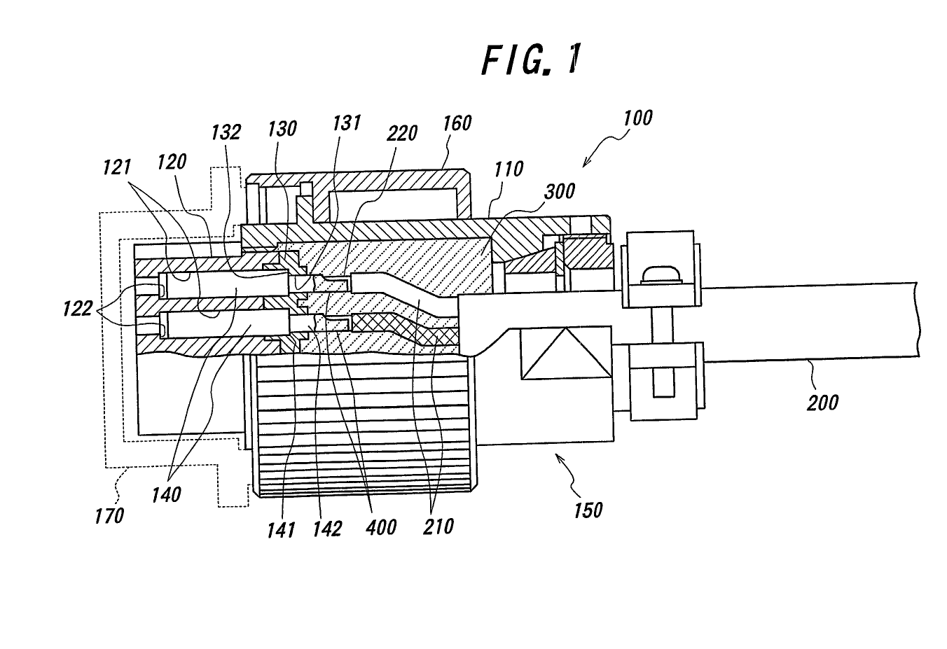

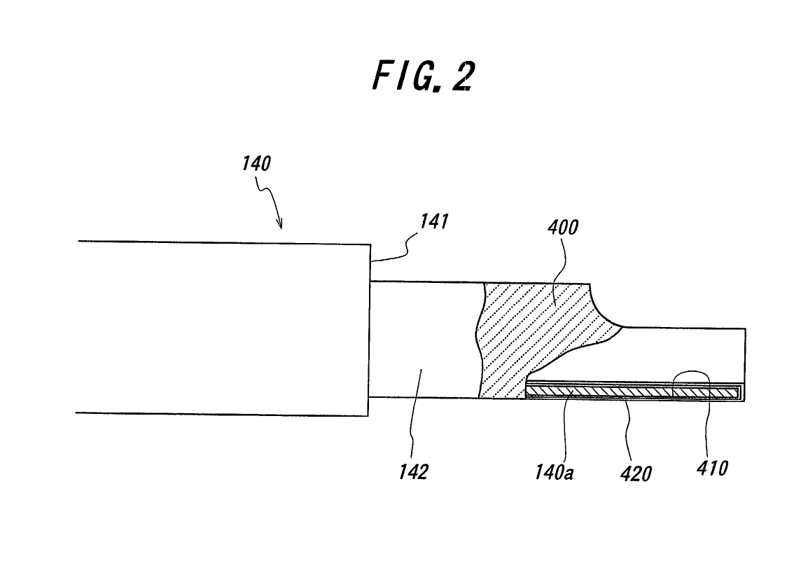

In FIG. 1 is shown an embodiment of the electric connector according to the invention and FIG. 2 shows a portion of the metal terminal thereof.

In FIGS. 1 and 2, numeral 100 is a connector body, numeral 110 an armor metal shell having a cylindrical shape, numeral 120 a front insert mounted at one side (front end side) of the cylindrical armor shell by screwing or the like and composed of a columnar block body of an insulating resin, numeral 130 a rear insert fitted at a rear side of the front insert and composed of a thin disc-shaped block body of an insulating resin, numeral 140 a metal terminal (contact) held at a state of sandwiching between both the inserts 120 and 130, numeral 150 a cramp portion for a cable built in the other side (rear end side) of the cylindrical armor shell 110, numeral 200 a cable fixed by the cramp portion 150 and inserted into the cylindrical armor shell 110, and numeral 300 a filler made of an insulating material filled in an empty space portion of the cylindrical armor shell 110.

Moreover, numeral 160 is a cylindrical coupling mounted on an outer circumference of the armor shell 110 and used for fixing mating connector, and numeral 170 a resin cap covering an outer protruding portion of the front insert 120 in non-use.

In this embodiment, the contact 140 is a contact having a top of a cylindrical type (a pipe type) so as to insert a contact of mating connector (a top pin portion of a pin-type contact) thereinto.

Moreover, contrary to this, the contact 140 may be a pin type and mating contact may be a pipe type.

The top of the contact 140 is inserted in a contact hole 121 of the front insert 120 from the inside (the right side in FIG. 1) thereof and contacted with and fixed to a diameter-reduced step portion 122 in the contact hole 121, while the rear end of the contact 140 is fitted into a contact hole 131 of the rear insert 130 and a diameter-reduced step portion 141 of the contact 140 is contacted with and fixed to a diameter-reduced step portion 132 in the contact hole 131.

To a portion 142 of the contact 140 to be joined protruding through the contact hole 131 of the rear insert 130 is soldered a core conductor 220 leading from a cable core 210 leaded from the cable 200 with a Pb-free solder such as Sn-3.5Ag-0.75Cu or the like mentioned above.

In at least a joint portion of the contact 140, as shown in FIG. 2, a Pb-free surface-treated layer 400 containing no lead is formed on a metal material 140a such as copper alloy or the like. The surface-treated layer 400 is constituted with a Ni layer 410 formed as an under layer and a Sn-Cu alloy layer 420 formed on the Ni layer and having a copper content of 0.5-5.0 mass %.

Moreover, each of the Ni layer 410 and the Sn-Cu alloy layer 420 is preferable to be formed as a plated layer by a wet plating method.

The Ni layer 410 is a layer indispensable as the under layer for improving an adhesion of the Sn-Cu alloy layer 420 to the metal material and preventing the occurrence of a needle-shaped whisker. Because, when the Sn-Cu alloy layer 420 is directly formed on the metal material, or when a metal layer such as copper layer other than the Ni layer is formed as an under layer and the Sn-Cu alloy layer 420 is formed thereon, the needle-shaped whisker is apt to be easily created, and if the needle-shaped whisker is created, there is caused a problem that a short-circuit is apt to occur between the terminals.

Moreover, the Ni layer 410 is preferable to have a thickness of 0.5-4.0 μm. When the thickness of the Ni layer 410 is less than 0.5 μm, elements included in the metal material tend to diffuse, while when it exceeds 4.0 μm, the spring property tends to be lost.

The reason why the upper layer is made from the Sn-Cu alloy layer 420 having a copper content of 0.5-5.0 mass % is due to the fact that the Sn-Cu alloy layer 420 is very excellent in the weldability through the soldering or the like as compared with the other metal layer and alloy layer and can surely perform the junction by a welding. As seen from the following test results, when the copper content is less than 0.5 mass %, whiskers as a fine needle-shaped projection are apt to be easily created on the surface of the Sn-Cu alloy layer 420, while when it exceeds 5.0 mass %, the corrosion resistance against corrosive gases and the wettability lower.

Further, the thickness of the Sn-Cu alloy layer 420 is preferable to be within a range of 2-8 μm. When the thickness of the Sn-Cu alloy layer 420 is less than 2 μm, the wettability tends to lower, while when it exceeds 8 μm, the improving effect is not recognized and the rise of the product cost is merely caused, and also as the thickness of the plated layer to be formed becomes thick, there are problems in view of the production that the plating rate lowers and the time for forming the plated layer becomes too long and the like.

Thus, when the Sn-Cu alloy layer 420 is formed as an outermost layer (a surface layer) in the surface-treated layer 400 of the contact 140, if the Pb-free solder such as Sn-3.5Ag-0.75Cu or the like as mentioned above is used in the subsequent joining to the core conductor 220 of the cable 200, the perfectly Pb-free junction can be obtained.

As a result, even if the connector body 100 will be disposed later, there is removed a risk that the lead (Pb) constituent is discharged into the outside.

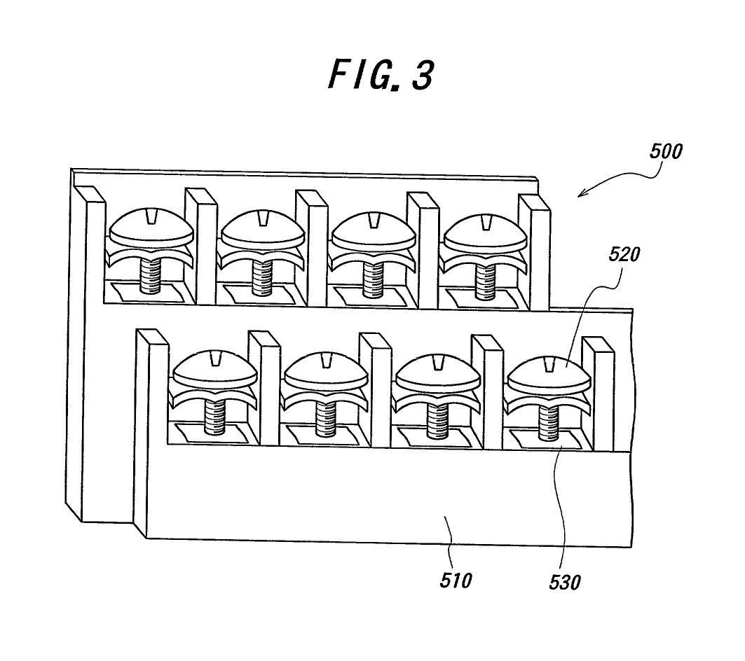

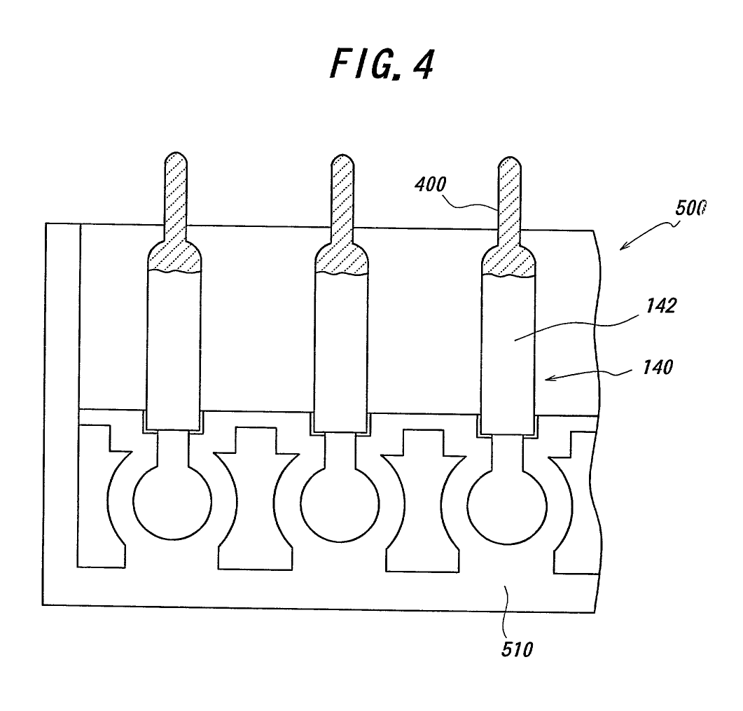

FIGS. 3 and 4 show another embodiment of the electric connector according to the invention.

In the connector body 500 shown in FIGS. 3 and 4, a plurality of connector screws 520 and clamp attachments 530 are arranged on an upper surface side of a connector housing 510 comprised of a block body of an insulating resin, while metal terminals 140 connected to the respective clamp attachments are arranged at a bottom side thereof. In use, the connector body 500 is mounted on a side of an electronic appliance, so that the metal terminal 140 is a portion to be soldered to a metal layer (land) portion located at a substrate of the electronic appliance.

In this embodiment, the surface-treated layer 400 comprised of Ni layer and Sn-Cu alloy layer having a copper content of 0.5-5.0 mass % is formed on a portion 142 of the metal terminal 140 to be joined likewise the case of the above connector body 100.

Even in the joining of the metal terminal 140 to the metal layer located at the substrate side, the Pb-free solder such as Sn-3.5Ag-0.75Cu or the like is used, so that the perfectly Pb-free junction is obtained.

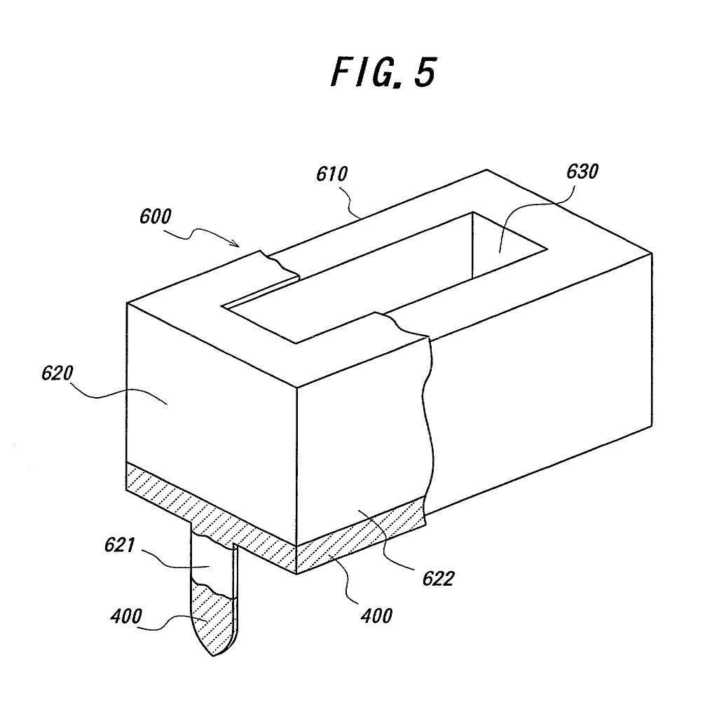

Furthermore, FIG. 5 shows the other embodiment of the electric connector according to the invention.

A connector body 600 shown in FIG. 5 is constituted by armoring a metal shell 620 onto an outer surface side of a connector housing 610 comprised of a block body of an insulating resin. In use, the connector body 600 is mounted on a side of an electronic appliance, in which a leg portion 621 extended from a side of the metal shell 620 is fitted into a metal through-hole or the like located at the substrate side and soldered thereto, or a portion 622 of the metal shell 620 contacting with the metal layer (land) portion located at the substrate side is soldered to the metal layer portion. Moreover, an open portion 630 formed in the upper surface side of the connector body 600 is a fit hole for inserting a fit portion of mating connector and a given metal terminal is built in the open portion 630.

In this embodiment, the surface-treated layer 400 comprised of Ni layer and Sn-Cu alloy layer having a copper content of 0.5-5.0 mass % is formed on a portion to be joined such as leg portion 621 of the metal shell 620 or the portion 622 contacting with the substrate side likewise the case of the above connector body 100.

Even in the joining of the leg portion 621 or the contacting portion 622 to the metal layer located at the substrate side, the Pb-free solder such as Sn-3.5Ag-0.75Cu or the like is used, so that the perfectly Pb-free junction is obtained.

The following examples are given in illustration of the invention and are not intended as limitations thereof.

Various tests (corrosion resistance, presence or absence of whisker, wettability, peeling strength and contact resistance) are made with respect to samples (Examples 1-4) in which a Sn-Cu plated layer satisfying the condition of the invention as shown in Table 1 is formed as an upper layer on a Ni plated layer, samples (Comparative Examples 1 and 2) in which a Sn-Cu plated layer lacking the condition of the invention is formed as an upper layer on a Ni plated layer, a sample (Comparative Example 3) in which a Sn-Cu plated layer satisfying the condition of the invention is directly formed on a metal material, a sample (Comparative Example 4) wherein a Sn-Cu plated layer satisfying the condition of the invention is formed as an upper layer on a Cu plated layer, and a sample (Conventional Example) in which the conventional solder plated layer having a usual lead content is formed as an upper layer on a Ni plated layer. These test results are shown in Table 1 together with total evaluation.

Moreover, for simplifying the production of the sample, a copper alloy plate for the terminal is used as the metal material in which five copper alloy plates are provided per each sample. With respect to Examples 1-4, the Ni plated layer having a thickness of 1 mm is formed on a given portion of the copper alloy plate and then the Sn-Cu alloy plated layer having the thickness of 4 mm is formed on the Ni plated layer.

The test for evaluating the corrosion resistance is performed by placing each sample in an atmosphere of a corrosive gas and observing a degree of change in color. In this case, the test temperature is 40° C., the humidity is 80%, the corrosive gas is hydrogen sulfide gas (H₂S) of 5 ppm, the test time (the exposing time) is 300 hours. In each sample, the case that color does not change is represented by “◯” as a good corrosion resistance and the case that color changes is represented by “X” as a bad corrosion resistance.

As to the test for examining the presence or absence of the whisker, the following four tests (1)-(4) are made on four test pieces prepared every the sample and thereafter the Sn-Cu alloy plated layer is observed by an electron microscope at 2000 magnifications to examine the presence or absence of the whisker as a fine needle-shaped projection. In the different tests of the four test pieces every the sample, the absence of the whisker is represented by “◯” and the presence of the whisker is represented by “X”.

TABLE 1

| | Surface-treated layer | | Test results | | | | | |
|---|---|---|---|---|---|---|---|---|
| | (Plated layer) | | Corrosion | Presence or absence | | Peeling | Contact | Total |
| | Upper layer | Under layer | resistance | of whisker | Wettability | strength | resistance | evaluation |
| Example 1 | Sn-0.5 Cu | Ni | ◯ | ◯ | ◯ | ◯ | ◯ | ◯ |
| Example 2 | Sn-1.0 Cu | Ni | ◯ | ◯ | ◯ | ◯ | ◯ | ◯ |
| Example 3 | Sn-3.0 Cu | Ni | ◯ | ◯ | ◯ | ◯ | ◯ | ◯ |
| Example 4 | Sn-5.0 Cu | Ni | ◯ | ◯ | ◯ | ◯ | ◯ | ◯ |
| Comparative | Sn-0.4 Cu | Ni | ◯ | X | ◯ | ◯ | ◯ | X |
| Example 1 | | | | | | | | |
| Comparative | Sn-8.0 Cu | Ni | X | ◯ | X | ◯ | ◯ | X |
| Example 2 | | | | | | | | |
| Comparative | Sn-1.0 Cu | none | ◯ | X | ◯ | ◯ | ◯ | X |
| Example 3 | | | | | | | | |
| Comparative | Sn-1.0 Cu | Cu | ◯ | X | ◯ | ◯ | ◯ | X |
| Example 4 | | | | | | | | |
| Conventional | Sn-10.0 Pb | Ni | ◯ | ◯ | ◯ | ◯ | ◯ | ◯ |
| Example | | | | | | | | |

(1) Test 1: The test piece is left to stand in air for 3 months;

(2) Test 2: The test piece is subjected to a thermal shock test 2000 cycles when 1 cycle is a series of keeping at −40° C. for 30 minutes, raising temperature, keeping at 85° C. for 30 minutes, dropping temperature, and keeping at −40° C. for 30 minutes;

(3) Test 3: The test piece is subjected to a high-humidity isothermal test of keeping at 85° C. and a humidity of 85% for 2000 hours; and

(4) Test 4: The test piece is subjected to an isothermal test of keeping at 50° C. for 2000 hours.

The test for evaluating the wettability is performed by applying a Pb-free solder flux of Sn-3.5Ag-0.75Cu mixed with 30% of rosin onto the Sn-Cu alloy plated layer of the above each sample, whereby the wettability is evaluated by the degree of adhesion thereof. In this case, a bath temperature of the Pb-free solder is 245° C. In each sample, the good adhesion is represented by “◯” and the bad adhesion is represented by “X”.

The peeling strength is measured by applying a Pb-free solder flux of Sn-3.5Ag-0.75Cu mixed with 30% of rosin onto the Sn-Cu alloy plated layer of the above each sample, connecting to a core conductor of a cable, and adding external force to the joint portion. In each sample, the case that the peeling strength is high is represented by “◯” as a good property and the case that the peeling strength is low is represented by “X” as a bad property.

The contact resistance is measured by contacting a gold-plated probe with the above each sample and changing a contact weight from 0N to 5N. In each sample, the case that the resistance is stable is represented by “◯” as a good property and the case that the resistance is unstable is represented by “X” as a bad property.

As seen from the test results of Table 1, good results on all tests are obtained in Examples 1-4, which are substantially the same as those in the conventional Example provided with the usual solder plated layer containing lead. On the other hand, the formation of the whisker is observed in Comparative Examples 1, 3 and 4 lacking the condition of the invention, and also the corrosion resistance and the wettability are degraded in Comparative Example 2.

In the invention, the electric connector using the metal terminal or the metal shell is not limited to the above each embodiment.

As seen from the above, in the electrical connector according to the invention, the surface-treated layer formed on the portion of the metal terminal or the metal shell to be joined to the core conductor or the metal layer of the substrate is a Pb-free surface-treated layer comprised of the Ni layer and the Sn-Cu alloy layer having a copper content of 0.5-5.0 mass %, whereby the joint portion of the metal terminal or the metal shell can be formed at a lead-free state.

Therefore, if the Pb-free solder is used in the joining to the Sn-Cu alloy layer, the perfectly Pb-free junction is obtained, whereby the problems that the environment is polluted by disposing the connector later are fundamentally solved.

And also, the properties of the surface-treated layer comprised of the Ni layer and the Sn-Cu alloy layer are equal to those of the conventional lead-containing solder plated layer forming no whisker.

Furthermore, it is possible to form the Sn-Cu alloy plated layer at a low cost as compared with the other Ag-containing plated layer and the like. And also, the plating solution for the formation of the Sn-Cu alloy plated layer is good in the stability and the amount of additives such as gloss agent and the like may be only small, so that the maintenance of the plating solution is performed easily.

What is claimed is:

1. In an electric connector comprising a metal terminal joined to a core conductor and/or a metal layer portion of a substrate, the improvement wherein a Ni layer as an under layer is formed on at least a portion of the metal terminal to be joined, and a Sn-Cu alloy layer having a copper content of 0.5-5.0 mass % is further formed on the Ni layer.

2. In an electric connector comprising a metal shell joined to a metal layer portion of a substrate, the improvement wherein a Ni layer as an under layer is formed on at least a portion of the metal shell to be joined, and a Sn-Cu alloy layer having a copper content of 0.5-5.0 mass % is further formed on the Ni layer.

3. An electric connector according to claim 1 or 2, wherein both the Ni layer and the Sn-Cu alloy layer are formed by a wet plating method.
